(19) United States
(12) Patent Application Publication
(10) Pub. No.: US 2003/0131744 A1
(43) Pub. Date: Jul. 17, 2003

(54) Chill roll with porous surface

(76) Inventors: Neil Doherty, Durham, NH (US); Kent Dirksen Kasper, Portsmouth, NH (US)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/043,976

(22) Filed: Jan. 11, 2002

(51) Int. Cl. B41F 13/10

(52) U.S. Cl. 101/375

(57) ABSTRACT

A chill roll for a web printing press includes a cylindrical drum. A porous layer is provided at a circumference of the drum and configured to provide a pathway for air from a first location between the chill roll and a web passing over the chill roll and a second location having a lower air pressure. Air between the chill roll and the web is thereby removed, providing improved heat transfer from the web to the chill roll.

### BACKGROUND

The present invention relates generally to chill rolls for web offset printing presses, and in particular to a chill roll having a porous surface.

In web offset printing presses, ink is applied to an elongated web of paper or other material as the web is moved lengthwise through the printing press. The freshly printed web is moved through a drier, which elevates the temperature of the web. The web is then moved through a chill roll assembly in order to cool the heated web and to set the ink. A chill roll assembly typically included a succession of rolls which are cooled by water or other coolant flowing through the interior of the rolls.

A chill roll assembly is described in the “Handbook of Printmedia,” Helmut Kipphan, Springer-Verlag Berlin Heidelberg 2001, Germany, pp. 269-70.

Various devices have been used to improved the heat transfer between the web and the chilled rolls. Many of these devices are aimed at reducing or eliminating the thin layer of air which typically forms between the moving web and the rotating roll due to entrainment or other processes. The thin layer of air typically may have a thickness of about 0.1 mm to about 0.13 mm. This thin layer of air acts as an insulator and may markedly degrade the heat transfer between the web and the chill roll.

Prior attempts at reducing or eliminating this air layer are described in the following patents: 1) U.S. Pat. No. 4,476,636 describes rolls which are rotated opposite the direction of web travel to “scrub” the web of the air layer; 2) U.S. Pat. No. 5,036,600 describes an arrangement with chill rolls in a closely spaced relationship whereby the web path around the rolls acts to scrub off the air layer; 3) U.S. Pat. Nos. 4,369,584 and 5,416,984 describe using jets of air impinging upon the surface of the web to force it closer to the roll surface; 4) U.S. Pat. Nos. 5,111,595 and 5,571,564 describe additional “nip rolls” designed to force out the air layer and put the web and chill roll into intimate contact; and 5) U.S. Pat. No. 5,275,103 describes using attractive electrostatic charges placed on the web and chill roll to reduce the gap between them.

These prior attempts at removing the air layer have proven not fully satisfactory for various reasons. Scrubbing methods cannot totally eliminate the entrainment of air between the web and the chill roll. Air jets typically cannot overcome the high pressures between the web and chill roll associated with high speed operation. Nip rolls introduce unwanted complexity as the nip roll itself must now be cooled, and care must be taken so that the nip roll does not mar the web or the printed ink films. Likewise, electrostatic methods add complexity and are not fully effective.

U.S. Pat. No. 4,688,784 describes a sheet-supporting transfer drum (see FIG. 9, reference numeral 16) with a perforated surface and which is connected to a suction device so that air is blown out of or sucked into the transfer drum through the perforations and a sheet to be transferred properly contacts the cylinder guiding surface (see column 7, lines 21-31 and 59-68). U.S. Pat. No. 3,542,358 describes a sheet-folding device including a sheet drum with an outer peripheral wall made at least partly of an air permeable material. Such a material may be a sintered material or a porous plastic (see column 1, lines 72-74). Neither of these patent documents describe a chill roll with which the air layer between the web and the chill roll may be reduced or eliminated.

### SUMMARY OF THE INVENTION

The present invention provides a chill roll for a web printing press. The chill roll includes a cylindrical drum and a porous layer disposed at a circumference of the drum. The porous layer is configured to provide a pathway for air from a first location between the chill roll and a web passing over the chill roll and a second location having a lower air pressure.

The porous layer may be attached to a circumferential surface of the drum.

The porous layer may integral with a circumferential surface of the drum.

The porous layer may form a circumferential surface of the drum.

The pathway may be configured to enable the air to move in a radial direction. Moreover, the pathway may be further configured to enable the air to move in at least one of a lateral and a circumferential direction.

The porous layer may include a matrix of material.

The porous layer may include a fibrous material.

The porous layer may include a foamed material.

The porous layer may define at least one of a hole, a slot and a tube so as to provide the pathway.

The porous layer may include a material having a high thermal conductivity.

The porous layer may include at least one of steel, aluminum and copper.

The porous layer may have a thickness of from about 1 mm to about 2.5 mm.

The second location may be at a lateral edge of the drum.

The air may be entrained at the first location.

The pathway may be configured to enable the air to move from the first location so as to improve a heat transfer between the web and the chill roll.

The drum may define a coolant inlet and a coolant outlet configured for circulating a coolant through an interior space defined by the drum.

The present invention also provides a printing press. The printing press includes a cylindrical chill roll having a porous layer disposed at a circumference of the chill roll and configured to provide a pathway for air from a first location between the chill roll and a web passing over the chill roll and a second location having a lower air pressure.

### BRIEF DESCRIPTION OF THE DRAWING

The present invention is elaborated upon below based on exemplary embodiments with reference to the accompanying drawing.

FIG. 1 shows a perspective view of a chill roll according to an embodiment of the present invention.

### DETAILED DESCRIPTION

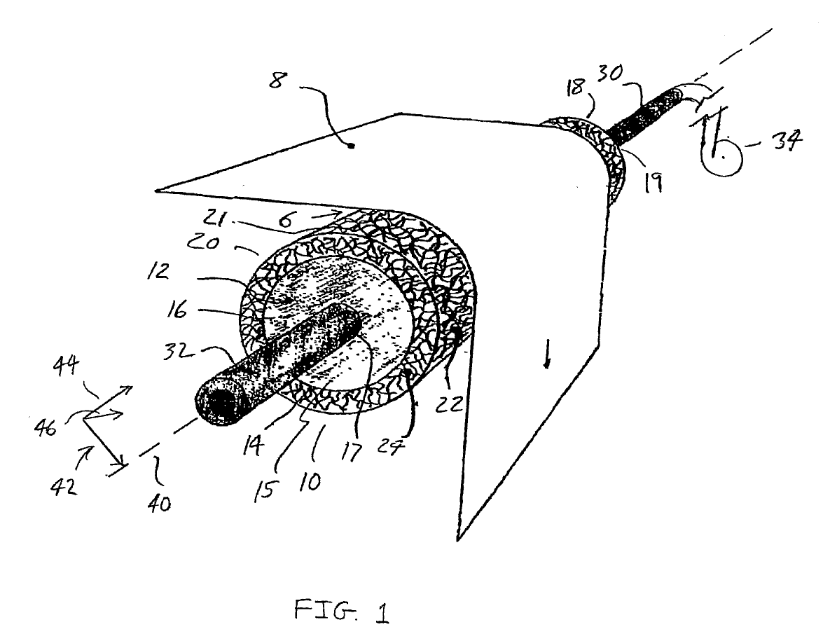

Referring to FIG. 1, a perspective view of a chill roll 10 according to an embodiment of the present invention is shown. Chill roll 10 includes cylindrical drum 12 having cylindrical surface 14 and disk-shaped lateral end surfaces 16 and 18 which together enclose an interior space 15. Porous layer 20 is disposed on cylindrical surface 14 and includes outer surface 21. Porous layer 20 rotates with cylindrical drum 12 as cylindrical drum 12 rotates about axis 40 defined by the drum. Opening 17 is provided in end surface 16 for coolant outlet pipe 32 and opening 19 is provided in end surface 16 for coolant inlet pipe 30. Coolant circulating system 34 is provided for circulating coolant through coolant inlet pipe 30, through interior space 15, and out coolant outlet pipe 32 to transfer heat from web 8 passing over chill roll 10.

Web 8 contacts or at least nearly contacts chill roll 10, and specifically surface 21 of porous layer 20, at area 6.

Radial direction 42, longitudinal direction 44 and circumferential direction 46 may be defined relative to cylindrical drum 12 and porous layer 20. Radial direction 42 points radially toward axis 40. Longitudinal, or lateral, direction 44 is parallel to axis 40. Circumferential direction 46 lies generally orthogonal to radial direction 42 and longitudinal direction 44 so as to be parallel to a tangent of surface 21 of cylindrical drum 12 or of surface 21 of porous layer 20.

Cylindrical drum 12 may be made of a metal, plastic, composite or any other suitable material. The construction of cylindrical drum 12 may be of any suitable configuration for a chill roll as would be known to those of skill in the art.

Coolant circulation system 34 may include one or more pumps and heat exchangers for moving a coolant through interior space 15 of cylindrical drum 12 and transferring heat from the coolant so as to cool chill roll 10. The construction of such a system would be known to those of skill in the art.

Porous layer 20 has one or more passageways 22 providing a pathway for air tending to be entrained and/or trapped at area 6 to move to areas of lower pressure. Porous layer 20 preferably is thereby maintained in contact with web 8 so that heat is conducted from the web to the coolant flowing through interior space 15 of cylindrical drum 12.

Passageways 22 may be pores, spaces, voids, holes, tubes or slots, or the like, or any combination thereof. Porous layer 20 may be a matrix or mesh of any suitable material having such passageways 22. Porous layer 20 may, for example, have the structure of a metallic filter. Alternatively, porous layer 20 may be made of a “foamed” metal or other foamed material. In other embodiments of the present invention, porous layer 20 may be made from a solid material in which radial or interconnected radial and longitudinal holes, tubes or slots, or the like have been formed so create passageways 22. Porous layer 20 may include any suitable combination of individual or interconnected passageways. Porous layer 20 may be made of a matrix of high thermal conductivity material, such as steel, aluminum or copper, for example. Porous layer 20 may have, for example, a thickness of from about 1 mm to about 2.5 mm. In other embodiments of the present invention, porous layer 20 may have a greater or a lesser thickness outside this range.

In some embodiments of the present invention porous layer 20 may be a layer, for example in the form of a sleeve, added over the outer surface of an otherwise conventional chill roll. In other embodiments of the present invention porous layer 20 may be formed integrally with surface 14 of cylindrical drum 12 during manufacture of the chill roll. In yet other embodiments of the present invention, porous layer 20 may form surface 14 itself. Any of various suitable manufacturing methods may be using to form a chill roll having porous layer 20 according to the present invention.

Passageways 22 preferably provide a pathway for air to move from area 6 in radial direction 42 and at least laterally in longitudinal direction 44 and/or circumferentially in circumferential direction 46 and/or in directions opposite to directions 44 and/or 46. In this way, higher pressure air at area 6 may move to lower air pressure areas, near lateral end surfaces 16 and 18, for example. In certain embodiments of the present invention, passageways 22 may lead from surface 21 of porous layer 20 to lower pressure areas in interior space 15 of cylindrical drum 12.

By providing a path for higher pressure air to move from area 6 to an area of lower pressure, the present invention may reduce or eliminate an air layer between web 8 and chill roll 10. Heat transfer from web 8 to chill roll 10 may thereby be improved.

It will of course be understood that the present invention has been described above only by way of example and that modifications of details can be made within the scope of the invention.

What is claimed is:

1. A chill roll for a web printing press comprising:
a cylindrical drum; and
a porous layer disposed at a circumference of the drum and configured to provide a pathway for air from a first location between the chill roll and a web passing over the chill roll and a second location having a lower air pressure.

2. The chill roll as recited in claim 1 wherein the porous layer is attached to a circumferential surface of the drum.

3. The chill roll as recited in claim 1 wherein the porous layer is integral with a circumferential surface of the drum.

4. The chill roll as recited in claim 1 wherein the porous layer forms a circumferential surface of the drum.

5. The chill roll as recited in claim 1 wherein the pathway is configured to enable the air to move in a radial direction.

6. The chill roll as recited in claim 5 wherein the pathway is further configured to enable the air to move in at least one of a lateral and a circumferential direction.

7. The chill roll as recited in claim 1 wherein the porous layer includes a matrix of material.

8. The chill roll as recited in claim 1 wherein the porous layer includes a fibrous material.

9. The chill roll as recited in claim 1 wherein the porous layer includes a foamed material.

10. The chill roll as recited in claim 1 wherein the porous layer defines at least one of a hole, a slot and a tube so as to provide the pathway.

11. The chill roll as recited in claim 1 wherein the porous layer includes a material having a high thermal conductivity.

12. The chill roll as recited in claim 11 wherein the porous layer includes at least one of steel, aluminum and copper.

13. The chill roll as recited in claim 1 wherein the porous layer has a thickness of from about 1 mm to about 2.5 mm.

14. The chill roll as recited in claim 1 wherein the second location is at a lateral edge of the drum.

15. The chill roll as recited in claim 1 wherein the air is entrained at the first location.

16. The chill roll as recited in claim 1 wherein the pathway is configured to enable the air to move from the first location so as to improve a heat transfer between the web and the chill roll.

17. The chill roll as recited in claim 1 wherein the drum defines a coolant inlet and a coolant outlet configured for circulating a coolant through an interior space defined by the drum.

18. A web printing press comprising a cylindrical chill roll including a porous layer disposed at a circumference of the chill roll and configured to provide a pathway for air from a first location between the chill roll and a web passing over the chill roll and a second location having a lower air pressure.

19. The web printing press as recited in claim 18 wherein the pathway is configured to enable the air to move from the first location so as to improve a heat transfer between the web and the chill roll.

20. The web printing press as recited in claim 18 wherein the pathway is configured to enable the air to move in a radial direction and in at least one of a lateral and a circumferential direction.
